(19) United States
(12) Patent Application Publication
(10) Pub. No.: US 2012/0241074 A1
(43) Pub. Date: Sep. 27, 2012

(54) Zoned Resistance Heat Seal Element

(76) Inventor: Michael Parkinson, Germantown, WI (US)

(21) Appl. No.: 13/069,255

(22) Filed: Mar. 22, 2011

(51) Int. Cl. B32B 37/06; B32B 7/02; B31B 1/62

(52) U.S. Cl. 156/64; 156/349; 156/60; 428/212

(57) ABSTRACT

A heat sealing apparatus and method of making a heat sealing apparatus comprised of a heat seal element with at least one resistance altering patch attached within or bordering and adjacent to the heating zone of the heat sealing element. The heat seal element has a quantified resistance value R₁, and the resistance altering patch has a quantified resistance value R₂. The heat seal element and at least one resistance altering patch are joined through at least one structural bonding junction.

### FIELD OF INVENTION

The present invention relates to the field of heat seal elements, and specifically to zoned resistance heat seal elements.

### BRIEF DESCRIPTION OF THE DRAWINGS

FIG. 1 illustrates an exemplary embodiment of a heat seal element.

FIG. 2 illustrates an exemplary embodiment of a heat seal element with a resistance altering patch.

FIG. 3a illustrates an exemplary embodiment of a heat seal element with a resistance altering patch sealing a product of multiple layers.

FIG. 3b illustrates an exemplary embodiment of a contoured resistance altering patch.

FIG. 4 is an exemplary embodiment of a heat seal element with a resistance altering patch adjacent to the heating zone.

FIG. 5a is an exemplary embodiment of a heat seal element with a resistance altering patch.

FIG. 5b is an alternative exemplary embodiment of a heat seal element with a resistance altering patch.

FIG. 5c is an exemplary embodiment of a heat seal element with multiple resistance altering patches.

FIG. 6 is an exemplary embodiment of a method to create a heat seal element with at least one resistance altering patch.

### TERMINOLOGY

As used herein, the term “coalescence” refers to a structural bond between at least one material created by melting, mixing and resolidifying a mixture of the at least one material. Coalescences are formed during welding.

As used herein, the term “cold zone” refers to an area of a heat seal element with a resistance atlering patch that is a cooler temperature relative to the rest of the heat seal element when the heat seal element is heated.

As used herein, the term “dimension” refers to any linear or non-linear measurement.

As used herein, the term “heating zone” refers to the portion of a heat seal element which contacts or thermally transfers heat to a product, packaging or material to be sealed.

As used herein, the term “heat seal” refers to a process of creating or a permanent or temporary attachment, cut, deformation or other modification of one or more structures or structural layers by the application of heat.

As used herein, the term “heat seal element” refers to a wire, band or other structure of a high resistance material which is used to heat seal.

As used herein, the term “heat seal profile” refers to the dimensions and shape of a heat seal element required to create a heat seal corresponding to the seal or cut necessary or desired to heat seal a product.

As used herein, the term “patch” refers to any structural configuration of any shape, contour, depth, and dimension, and may have aperatures or other textural characteristics, including, but not limited to grooves, indentations, raised portions, abrasions and combinations thereof. A patch may have a uniform or nonuniform thickness, may be constructed of multiple components or singularly constructed. A patch may be configured to conform to an underlying structure.

As used herein, the term “quantified resistance value” refers to a calculated or known resistance value for a material.

As used herein, the term “resistance” refers to a measure of the opposition of the passage of electric current through a material. Resistance is defined by the equation

$$R = \frac{V}{I} ,$$

where R is the resistance, V is the voltage, and I is the current. Resistance is measured in ohms.

As used herein, the term “resistance altering patch” refers to a portion of material with a resistance equal to or less than the resistance of a heat seal element which is affixed to a heat seal element to create a cold zone.

As used herein, the term “sealable material” refers to one or more materials or structures which may be bonded to themselves or each other. Sealable materials include, but are not limited to, plastics, fibers, fabrics, resins, biological materials, thermoplastics, heat-activated adhesive, metals, alloys, coated substrates, functionally equivalent materials and combinations thereof, with or without intervening material bonding layers and substances, and with or without structural modifications.

As used herein, the term “seal cycle” refers to a set of variables, including, but not limited to, time, temperature and pressure necessary to permanently or temporarily join at least one sealable material.

As used herein, the term “structural bonding junction” refers to a structural or physical point of affixation between a heat seal element and a resistance altering patch. A structural bonding junction may be created by various methods, including, but not limited to, micro/nano-welding, conductive adhesives, brazing, soldering, any other method of joining a resistance altering patch to a heat seal element and combinations of these methods.

### BACKGROUND

Heat seal bands are used to seal and cut packaging, products and other materials using heat. Heat seal bands may be used to seal monolayers or multiple layers, of similar or dissimilar materials, as long as one material contains a heat-activated adhesive or thermoplastic portion. Heat seal bands may also be of almost any shape and configuration to produce a specific seal shape and structure. Heat seal bands are commonly made from a high resistance metal, which heats as electricity moves through the material. To heat seal a material, the heat seal band is pressed against the product, packaging or other material to bond the layer or layers.

When creating a heat seal band, multiple factors must be taken into consideration. First, different materials bond at different temperatures. Temperatures may reach in the excess of 300° C., and the material used to create the heat seal band must be capable of withstanding the temperatures required to seal the product, packaging or material. The temperature of a heat seal band may be controlled by varying the voltage used. Different materials also require different heating times and pressures in order for a bond to develop. The heat seal bar material must also be able to provide the necessary force for the necessary time.

Heat seal bands must also be able to withstand the frequent heating and cooling that arises during use. When a material to be sealed or cut is in thermal contact with the heat seal band, the heating zone rapidly cools as heat transfers to the product, packaging or other material to generate the heat seal. The ends of the bands not in contact with the material to be sealed overheat. As a result, the ends of the heat seal band at the transition to the heating zone experience frequent heating and cooling and become weakened over time, eventually breaking if not replaced. However, replacing heat seal bands or making repairs after a heat seal band breaks results in downtime and stalled production, in addition to replacement or repair costs.

To help prevent the ends of heat seal bands from overheating and increase the usable life of heat seal bands, the ends are plated with copper. Copper is a lower resistance material than that of the heat seal band, and allows electricity to flow through the ends more freely, thus lowering the temperature of the heat seal band plated with copper.

Copper plating is also used on heat seal bands which create seals with gaps or unsealed portions. For example, it may be desirable to create a seal that does not seal in its entirety to allow access to an interior compartment. To create a heat seal band used to create a seal with an unsealed portion, the heat seal band is plated with copper where the portion of the packaging, product or other material that is not sealed contacts the heat seal band. The copper plating reduces the resistance, and therefore temperature, of that portion of the heat seal band, and no seal is formed in the portion of the material corresponding to the copper plating.

One problem known in the art with copper plating is the time and cost associated with plating a material with copper. First, the portion of the heat seal bar that is not to be copper plated must be completely masked. The heat seal bar is then soaked in a complexed bath with current running through it. Depending on the material being plated and the desired result, the heat seal band may need to be based coated with other materials, requiring additional baths, and additives may be required in the copper-plating bath. It is also necessary to carefully monitor and control the copper plating process to ensure a desired thickness is achieved.

Additionally, it is difficult to modify copper plating. For example, if a heat seal band was not completely masked, copper plating may extend too far or not far enough along the heat seal band. While it may be permissible to be approximate when copper plating the ends of a heat seal band, approximate measurements may not be tolerated when copper plating for a gap in a seal. To correct the copper plating, the heat seal band may need to be re-prepped and allowed to soak in the complexed bath again, or, depending on how much correction is needed, the heat seal band may need to be recreated from scratch.

The size of an area of copper plating is also limited to the size of a heat seal element.

### SUMMARY OF THE INVENTION

The present invention is a method of making and a heat sealing apparatus comprised of a heat seal element with at least one surface and a quantified resistance value R₁, at least one resistance altering patch with at least one surface and a quantified resistance value R₂ and at least one structural bonding junction joining the surfaces of the heat seal element and resistance altering patch.

Resistance altering patches may be used to cool the ends of a heat seal band and create areas of lower resistance and lower temperature to create a non-continuous seal. Resistance altering patches may also be quickly and easily attached to a heat seal band and modified.

### DETAILED DESCRIPTION OF INVENTION

For the purpose of promoting an understanding of the present invention, references are made in the text to exemplary embodiments of a heat seal element and resistance altering patches, only some of which are described herein. It should be understood that no limitations on the scope of the invention are intended by describing these exemplary embodiments. One of ordinary skill in the art will readily appreciate that alternate but functionally equivalent materials and methods may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

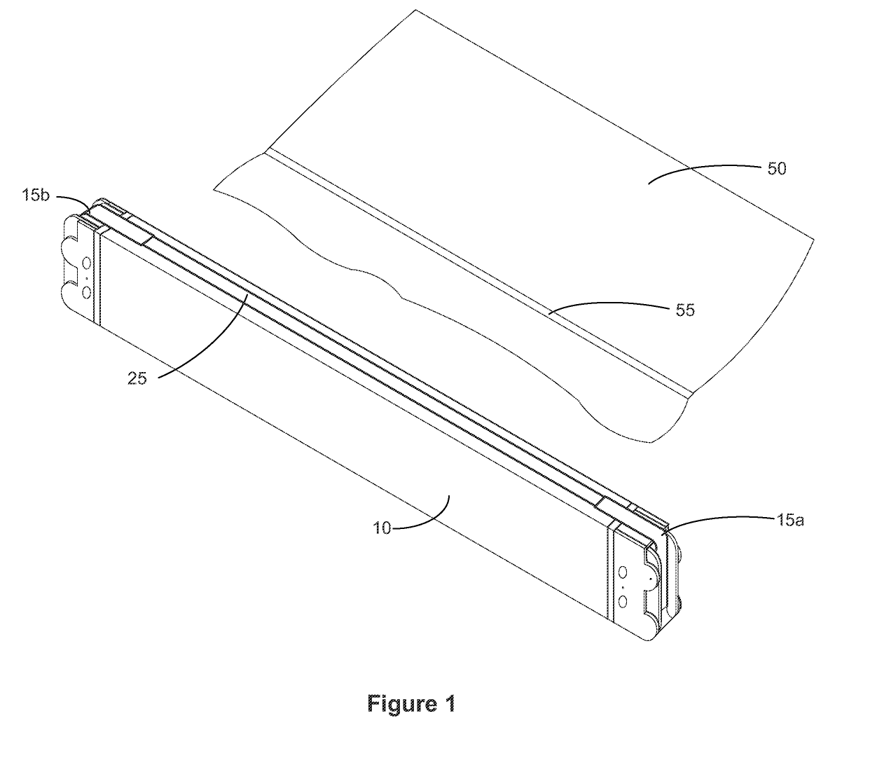

FIG. 1 illustrates an exemplary embodiment of heat seal jaw 10 with heat seal element 25. In the exemplary embodiment shown, heat seal element 25 is joined to heat seal jaw 10 at connections 15a, 15b, which contain copper plating. In further exemplary embodiments, connections 15a, 15b may not have copper plating. The heating zone is the portion of heat seal element 25 which thermally contacts product 50. Heat seal element 25 does not need to physically contact product 50 in order to create a seal. In some exemplary embodiments, heat seal element 25 may be in thermal contact with product 50 so that heat is transferred. In further exemplary embodiments, heat seal element 50 may contain a thermal layer, protective coating, non-stick coating or other coating which may physically or thermally contact product 50.

Product 50 contains a single linear seal 55, corresponding to the shape of heat seal element 25 and the time and pressure with which the heating zone was in contact with product 50. The shape of heat seal element 25 is a heat seal profile.

In the exemplary embodiment shown in FIG. 1, heat seal element 25 is made of a material with a resistance R₁. As electricity flows through heat seal element 25, the temperature of heat seal element 25 increases to heat seal product 50. Seal 55 corresponds to the profile of heat seal element 25.

In the exemplary embodiment shown in FIG. 1, heat seal element 25 is used to create seal 55. However, in further exemplary embodiments, heat seal element 25, and the time, temperature and pressure used, may be modified to cut, deform or otherwise modify product 50 along seal 55.

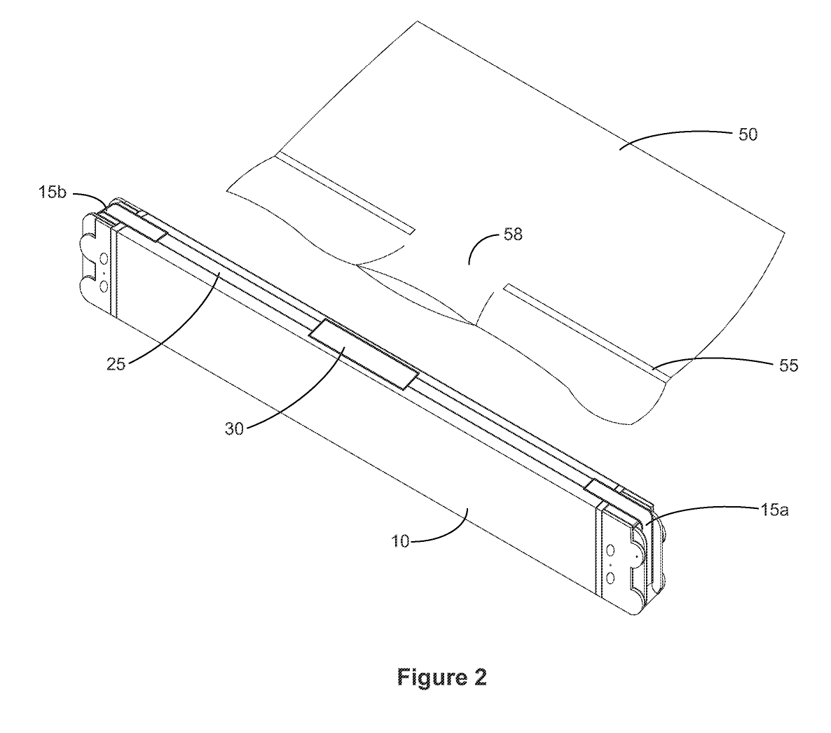

FIG. 2 illustrates an exemplary embodiment of heat seal jaw 10 with heat seal element 25 containing resistance altering patch 30 within the sealing zone. Resistance altering patch 30 has a resistance of R₂, which is less than or equal to the resistance of heat seal element 25 (R₁), so that the total resistance of the area of heat seal element 25 containing resistance altering patch 30 is lower than R₁. By lowering the resistance, the temperature of the patched portion of heat seal element 25 is cooler than the rest of heat seal element 25. The resulting seal 55 contains non-sealed portion 58, which corresponds to resistance altering patch 30.

As shown in FIG. 2, heat seal element 25 is used to create seal 55. However, in further exemplary embodiments, heat seal element 25, and the time, temperature and pressure used, may be modified to cut or otherwise deform product 50 along seal 55. Product 50 cut using heat seal element 25 with resistance altering patch 30 as shown in FIG. 2 would contain a cut corresponding to seal 55 with an uncut portion 58 corresponding to resistance altering patch 30.

In the exemplary embodiment shown in FIG. 2, resistance altering patch 30 is shown as slightly wider than heat seal element 25. In further exemplary embodiments, resistance altering patch 30 may be still wider or narrower than heat seal element 25. In still further exemplary embodiments, resistance altering patch may be of any size, shape or configuration which may be affixed to heat seal element. As shown in FIG. 2, resistance altering patch 30 is affixed to heat seal element 25 within the heating zone. In further exemplary embodiments, resistance altering patch may be affixed anywhere within heating zone, outside of the heating zone or adjacent to the heating zone. In still further exemplary embodiments, there may be more than one resistance altering patch.

By altering the dimensions of resistance altering patch 30, different cooling effects may be achieved. For example, a resistance altering patch with a greater cross-sectional area will provide a greater decrease in resistance, and a greater resulting decrease in temperature. However, if resistance altering patch 30 is made too thick, the resulting seal will contain indentations and the material may be damaged.

The effects of resistance altering patch 30 may also be varied by changing the material of resistance altering patch 30. In the exemplary embodiment shown in FIG. 2, resistance altering patch 30 is copper. However, resistance altering patch 30 may be any material with a resistance equal to or less than the resistance of heat seal element 25 and able to withstand the temperature required to form a seal.

In the exemplary embodiment shown in FIG. 2, seal 55 is continuous across product 50 and is shown as a permanent seal. In further exemplary embodiments, product material and heat seal element 25 may be configured to create a releasable seal.

In the exemplary embodiment shown in FIG. 2, resistance altering patch 30 is shown as micro/nano-welded to heat seal element 25. Micro/nano-welding resistance altering patch 30 to heat seal element 25 creates a series of structural junctions made of the material of heat seal element 25 and the material of resistance altering patch 30 coalesced together and solidified.

In further exemplary embodiments, resistance altering patch 30 may be adhered to heat seal element 25. Adhesives used to bond resistance altering patch 30 to heat seal element 25 should not require the application of heat at a bonding temperature above the temperature which will thermally alter the material of heat seal element 25 or resistance altering patch 30. An adhesive used may be electrically conductive, such as silver glue.

However, adhesives may degrade and alter the resistance of the resistance altering patch and the heat seal element, and it is difficult to control the conductive properties of an adhesive. Using an adhesive also introduces a third material to the heat seal element, which may change its heating, cooling and seal-making properties. Some adhesives also require heating in order to cure. It is important when using adhesives to attach resistance altering patch 30 that the temperature at which an adhesive cures is lower than the temperature which may thermally alter the material of heat seal element 25 or resistance altering patch 30. The adhesive must also be able to withstand the temperature of the sealing process in order to effectively bind heat seal element 25 and resistance altering patch 30.

In various embodiments, brazing or soldering may also be used to join resistance altering patch 30 with heat seal element 25, although both processes also introduces a third material and requires heating the materials in order to bind them. Brazing and soldering use a bonding metal which is heated to just above melting point and then cooled to join heat seal element 25 and resistance altering patch 30. The bonding metal used must be strong enough when cooled to securely bind heat seal element 25 and resistance altering patch 30 and able to withstand the temperatures of the sealing process.

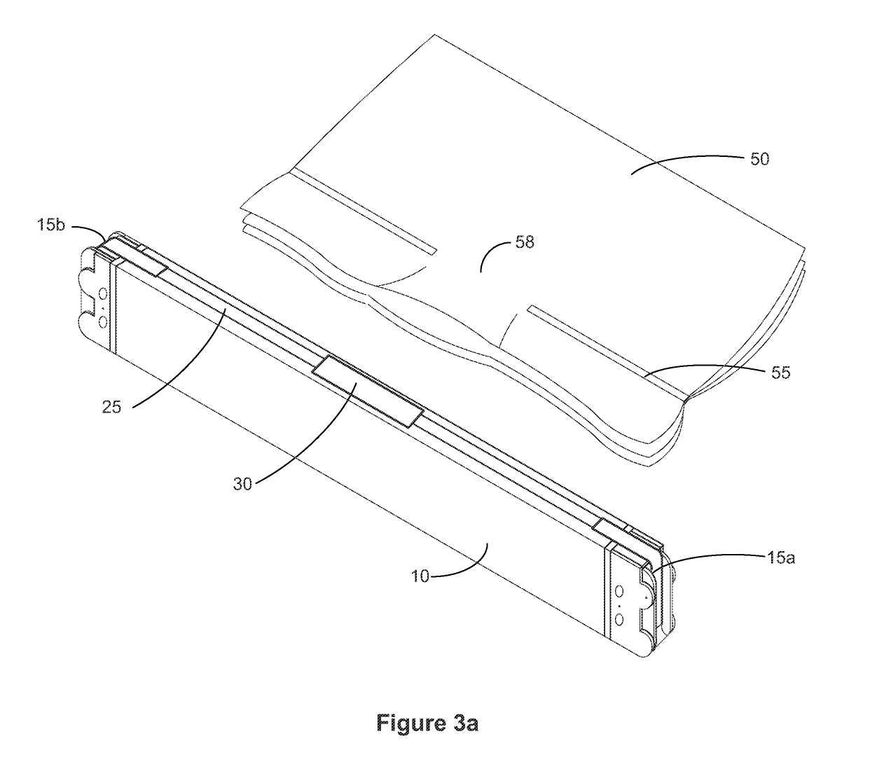

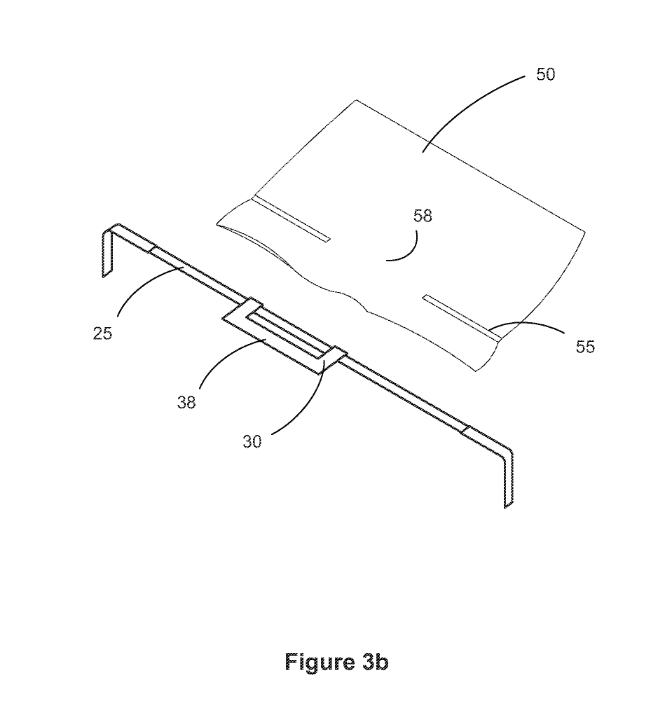

FIG. 3a illustrates an exemplary embodiment of heat seal jaw 10 sealing product 50 of multiple layers. To seal multiple layers, the sealing temperature, pressure and time may need to be altered. In the exemplary embodiment shown in FIG. 3, heat seal element 25 contains resistance altering patch 30 within heating zone. Resistance altering patch 30 is of a material with a resistance of R₂, which is less than or equal to the resistance of heat seal element 25, or R₁, and able to withstand the sealing temperature, pressure and time necessary to seal the multiple layers of product 50.

Seal 55 contains non-sealed portion 58, which corresponds to resistance altering patch 30. In the exemplary embodiment shown, non-sealed portion 58 on product 50 proceeds through every layer of product 50. In further exemplary embodiments, heat seal element 25 and resistance altering patch 30 may be configured so that product 50 contains a non-sealed portion 58 only affecting some of the layers, with remaining layers having a continuous seal. In still further exemplary embodiments, heat seal element 25, resistance altering patch 30 and the time, pressure and temperature of the seal cycle may be altered to completely or partially cut product 50.

FIG. 3b illustrates an exemplary embodiment of a contoured resistance altering patch 30. In the exemplary embodiment shown, resistance altering patch 30 contains contour 38. In further exemplary embodiments, resistance altering patch 30 may be differently contoured. In still further exemplary embodiments, resistance altering patch 30 may contain textures or have a variable thickness.

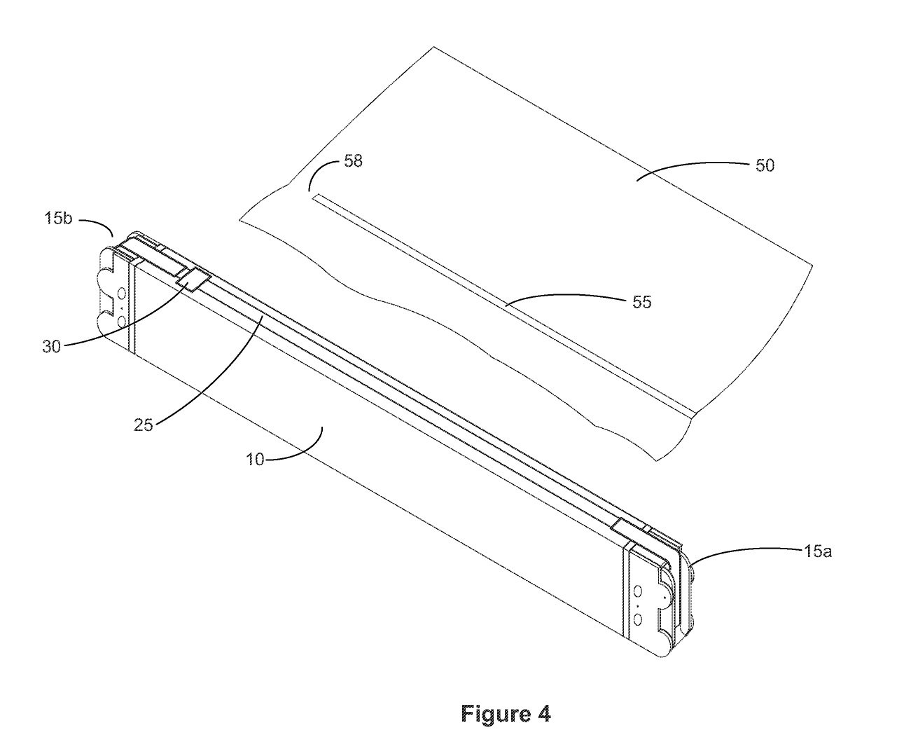

FIG. 4 is an exemplary embodiment of heat seal jaw 10 with heat seal element 25 and resistance altering patch 30 bordering and adjacent to the sealing zone. Product 50 contains resulting seal 55. Resistance altering patch 30 is not in the heating zone, and therefore does not create a gap in seal 55. In the exemplary embodiment shown in FIG. 4, resistance altering patch 30 is positioned to strengthen heat seal element 25 and create a more consistent temperature near ends 15a, 15b.

In further exemplary embodiments, resistance altering patch 30 may be positioned differently outside of and adjacent to the heating zone in order to strengthen and reinforce heat seal element 25 or create more even seals or cuts.

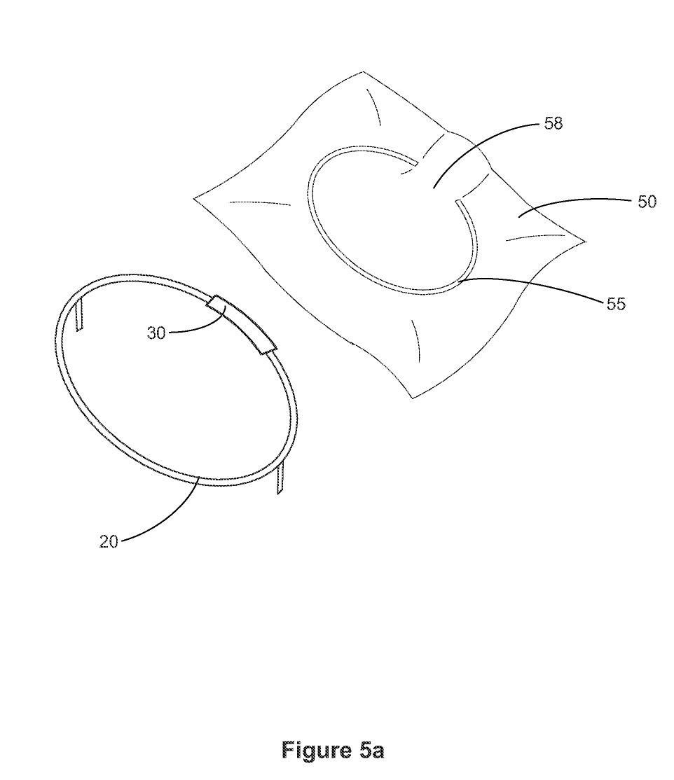

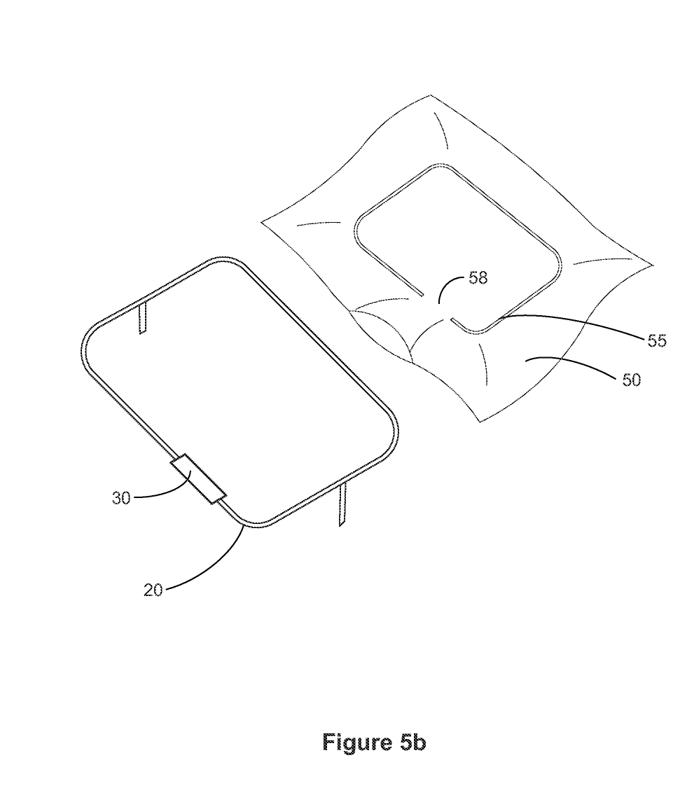

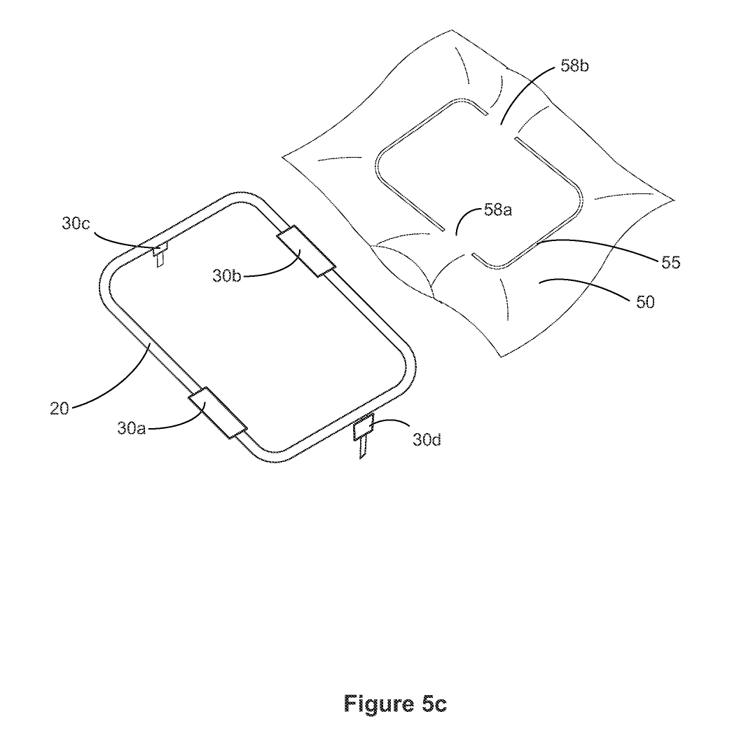

FIG. 5a is an exemplary embodiment of heat seal element 25 with resistance altering patch 30 with a circular heat seal profile. Resulting seal 55 on product 50 is circular with non-sealed portion 58 corresponding to resistance altering patch 30. FIG. 5b is an exemplary embodiment of heat seal element 25 with resistance altering patch 30 having a squared heat seal profile. Resulting seal 55 on product 50 is squared with non-sealed portion 58 corresponding to resistance altering patch 30.

As illustrated by the exemplary embodiments shown in FIGS. 5a and 5b, heat seal element 25 may be any shape or profile and contain resistance altering patch 30 in different positions.

FIG. 5c is an exemplary embodiment of heat seal element 25 with multiple resistance altering patches 30a, 30b, 30c, 30d. In the exemplary embodiment shown, heat seal element 25 is squared, with resistance altering patches 30a and 30b completely masking areas of heat seal element 25. Resistance altering patches 30c, 30d are shown adjacent to the heating zone of heat seal element 25.

Resulting seal 55 on product 50 contains non-sealed portions 58a and 58b which correspond to resistance altering patches 30a and 30b. In the exemplary embodiment shown in FIG. 5c, resistance altering patches 30c, 30d are specifically designed to cool portions of heat seal element 25 which are prone to overheating in order to create a more even seal 55 instead of a gap.

As illustrated by the exemplary embodiment in FIG. 5c, heat seal element 25 may contain more than one resistance altering patch 30, and resistance altering patches 30 may be in different locations. In further exemplary embodiments, resistance altering patches 30 may also be placed in other areas of high resistance to create more even seals in areas of heat seal element 25 that experience uneven heating and prevent damage to heat seal element 25. In still further exemplary embodiments, resistance altering patches 30 may be used to strengthen areas of a heat seal element which weaken as a result of frequent heating and cooling during use without changing properties or characteristics of the resulting seal.

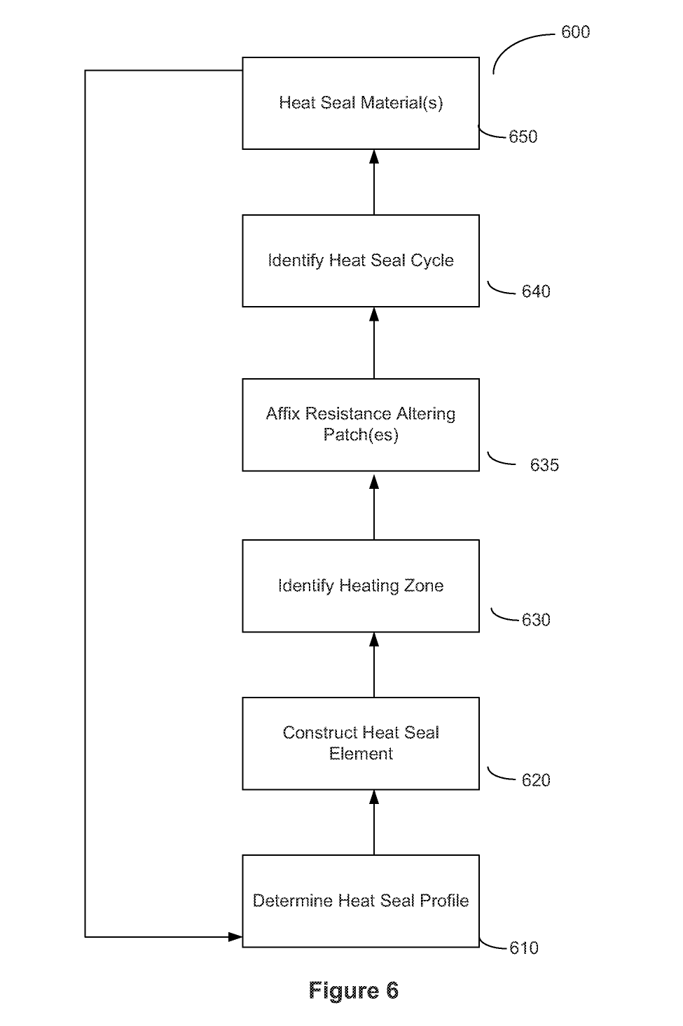

FIG. 6 is an exemplary embodiment of a method 600 to create a heat seal using a heat seal element with at least one resistance altering patch.

In Step 610, at least one heat seal profile must be determined for heat sealing one or more substrates. At least one material is required to form a seal forming a single structure with two or more substrates. In some exemplary embodiments, seals may be made from two or more materials. A heat seal element corresponding to the heat seal profile is constructed (Step 620). Seals may be a complex shape and require a heat seal element with a complex profile.

It is then necessary to identify at least one heating zone within the heat seal element (Step 630), which is the area of the heat seal element which is capable of being in thermal contact with the material being heat sealed.

Before affixing a resistance altering patch in Step 635, the heat seal element may be optionally tested to make sure the heat seal profile and seal cycle characteristics are correct.

In Step 635, at least one resistance altering patch capable of producing at least one cold zone is affixed to the heat seal element. A resistance altering patch may be affixed using micro/nano-welding, adhesives, brazing, soldering or any other attachment method known in the art to attach a material of equal or less resistance to a material with a first resistance.

A resistance altering patch may be affixed to a portion of a heat seal element in a known position in order to create a cold zone corresponding to a portion of non-seal on the product, packaging or other material being sealed. In other exemplary embodiments, resistance altering patches may be added to strengthen potential weak points in a heat seal element that experience frequent fluctuations in heating and cooling. In still further exemplary embodiments, resistance altering patches may be used to create a consistent temperature throughout the heating zone of a heat seal element to produce a consistent and even seal.

In some embodiments, it may be necessary to determine the exact size of the resistance altering patch in order to match precise seal requirements. It may also be necessary to calculate the thickness and other dimensions of a resistance altering patch to precisely match a cold zone temperature required for the seal to be created. Resistance (and therefore temperature) decreases as the cross sectional area increases, which means that a thicker resistance altering patch will create a cooler cold zone temperature. However, if a resistance altering patch is too thick, the material being sealed may be damaged.

In still further exemplary embodiments, it may be necessary to determine the material from which a resistance altering patch is made. While copper is the preferred material for resistance altering patches because it is an Ohmic material, different materials may be used to create different cooling effects to match a desired seal profile.

At least one seal cycle time, temperature and pressure is then identified in Step 640. Each material or combination of materials requires a certain temperature, heating time and pressure to develop a seal.

Finally, in Step 650, the materials are heat sealed using the heat seal element with the resistance altering patch consist with the calculated heat seal cycle. Steps 610-650 may be repeated as necessary if additional modifications or revisions to the heat seal element, resistance altering patch or seal cycle are needed.

What is claimed is:

1. A heat sealing apparatus comprised of:
at least one heat seal element having at least one surface, said at least one heat seal element having a quantified resistance value R₁ and a heating zone;
at least one resistance altering patch having at least one surface, said at least one resistance altering patch having a quantified resistance value R₂; and
at least one structural bonding junction joining said at least one surface and said at least one resistance altering patch.

2. The apparatus of claim 1 wherein said R₁ is greater than the quantified resistance value of copper.

3. The apparatus of claim 1 wherein said R₂ is equal to or less than said R₁.

4. The apparatus of claim 1 wherein said at least one structural bonding junction is comprised of at least one coalescence.

5. The apparatus of claim 4 wherein said structural connection is a micro/nano-welded coalescence.

6. The apparatus of claim 1 wherein said at least one structural bonding junction is an adhesive layer, said adhesive layer having a resistance equal to or less than R₁.

7. The apparatus of claim 6 wherein said adhesive is a layer formed by an epoxy.

8. The apparatus of claim 1 wherein said at least one resistance altering patch is fixedly attached to said at least one surface of said heat seal element within said heating zone.

9. The apparatus of claim 1 wherein said at least one resistance altering patch is fixedly attached to said at least one surface of said heat seal element outside of said heating zone.

10. The apparatus of claim 1 wherein said at least one resistance altering patch is fixedly attached to said at least one surface of said heat seal element adjacent to said heating zone.

11. The apparatus of claim 1 wherein said resistance altering patch has at least one dimension which is greater than the corresponding dimension of said heat seal element.

12. The apparatus of claim 1 wherein said resistance altering patch has at least one dimension which is less than the corresponding dimension of said heat seal element.

13. A heat sealing system comprised of:
at least one heat seal element having at least one surface, said at least one heat seal element having a quantified resistance value R₁;
at least one resistance altering patch having at least one surface, said at least one resistance altering patch having a quantified resistance value R₂; and
at least one structural bonding junction joining said at least one surface and said at least one resistance altering patch; and
at least one sealable material layer.

14. The system of claim 11 wherein said R₂ is equal to or less than said R₁.

15. The system of claim 11 wherein said at least one structural bonding junction is selected from the group consisting of a coalescence, a micro/nano-welded coalescence, an adhesive layer, an electrically conductive adhesive layer, an epoxy layer, a brazed layer, a soldered layer, and combinations thereof.

16. The system of claim 11 wherein said at least one sealable material layer is a material selected from the group consisting of plastics, fibers, fabrics, resins, biological materials, thermoplastics, heat-activated adhesive, metals, alloys, coated substrates, functionally equivalent materials and combinations thereof.

17. A method of heat sealing at least one substrate comprised of the steps of:
determining at least one heat seal profile for sealing one or more substrates;
constructing a heat seal element to correspond to said at least one heat seal profile;
identifying at least one heating zone within said at least one heat seal element;
affixing at least one resistance altering patch capable of producing at least one cold zone to said at least one heat seal element
identifying at least one seal cycle for exposing said one or more substrates to said heat seal element to which said at least one resistance altering patch has been affixed using the variables of time, temperature and pressure to determine a calculated seal cycle; and
heat-sealing at least one substrate consistent with said calculated seal cycle.

18. The method of claim 15 which further includes the step of determining the size of said at least one resistance altering patch to correspond to said heat seal profile.

19. The method of claim 15 wherein affixing is by micro/nano-welding.

20. The method of claim 15 wherein said affixing is by an adhesive.

21. The method of claim 15 which further includes the step of testing said at least one element and altering said at least one resistance altering patch.
